(19) United States
(12) Patent Application Publication
(10) Pub. No.: US 2026/0280197 A1
(43) Pub. Date: Sep. 17, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: MING-YI GONG, Huaian (CN); XUN WU, Huaian (CN); HUNG-CHI YU, New Taipei (TW); XIAO-HU YIN, Huaian (CN)

(21) Appl. No.: 19/565,090

(22) Filed: Mar. 12, 2026

(30) Foreign Application Priority Data
Mar. 12, 2025 (CN) 202510288358.7

(51) Int. Cl. H01R 13/6597; H01R 13/24; H01R 13/504

(52) U.S. Cl. CPC H01R 13/6597; H01R 13/24; H01R 13/5045

(57) ABSTRACT

An electrical connector includes an insulating housing, two first terminals adjacent to each other to form a differential terminal pair for transmitting differential pair signals, two second terminals for grounding, a shielding member arranged on the insulating housing, and a connecting base. The insulating housing has a fixing slot, two first receiving grooves and two second receiving grooves. The two first terminals are respectively received in the first receiving grooves. The two second terminals are respectively received in the second receiving grooves, and are positioned respectively on opposite sides of the differential terminal pair. The shielding member contacts the two second terminals and is positioned on one side of the differential terminal pair. The two first terminals are fixed to the connecting base, and the connecting base is assembled in the fixing slot of the insulating housing.

### BACKGROUND OF THE INVENTION

### Field of the Invention

In electronic devices, when multiple electrical connectors are arranged adjacent to each other, the signal transmitted by each connector is affected by the electromagnetic signals generated by the other connectors. Furthermore, as the frequency of the signals transmitted by the connectors increases, the influence of external electromagnetic signals on the transmitted signals increases the probability of electronic device malfunction. Therefore, shielding electrical connectors from electromagnetic signals is a pressing problem to be solved in the field.

### SUMMARY OF THE INVENTION

An electrical connector includes an insulating housing, two first terminals adjacent to each other to form a differential terminal pair for transmitting differential pair signals, two second terminals for grounding, a shielding member arranged on the insulating housing, and a connecting base. The insulating housing has a fixing slot, two first receiving grooves and two second receiving grooves. The first receiving grooves and the second receiving grooves are spaced apart in a first horizontal direction. The two first terminals are respectively received in the first receiving grooves. The two second terminals are respectively received in the second receiving grooves, and are positioned respectively on opposite sides of the differential terminal pair. The shielding member contacts the two second terminals and is positioned on one side of the differential terminal pair in a second horizontal direction. The first horizontal direction and the second horizontal direction are perpendicular to each other. The two first terminals are fixed to the connecting base, and the connecting base is assembled in the fixing slot of the insulating housing.

### BRIEF DESCRIPTION OF DRAWINGS

FIG. 1 shows a perspective view of an electrical connector according to a first embodiment of the present disclosure;

FIG. 2 shows a perspective view of a portion of the structure of FIG. 1;

FIG. 3 shows a perspective view of the embodiment of FIG. 2 from another perspective;

FIG. 4 shows an exploded view of the embodiment of FIG. 3;

FIG. 5 shows an exploded view of a first terminal and a connecting base of FIG. 4;

FIG. 6 shows an exploded view of an electrical connector according to a second embodiment of the present disclosure; and

FIG. 7 shows an exploded view of a first terminal, a connecting base, and a shielding cover of FIG. 6.

### DETAILED DESCRIPTION OF THE DRAWINGS

The technical solutions of the embodiments of the present disclosure will be clearly and completely described below with reference to the accompanying drawings. Obviously, the described embodiments are only a part of the embodiments of the present disclosure, and not all of them.

The term “plurality” in the present disclosure refers to two or more. Furthermore, it should be understood that in the description of the present disclosure, terms such as “first” and “second” are used only for the purpose of distinguishing descriptions and should not be construed as indicating or implying relative importance, nor should they be construed as indicating or implying order.

In the description of the embodiments of the present disclosure, words such as “exemplary” or “for example” are used to indicate examples, illustrations, or descriptions. Any embodiment or design scheme described as “exemplary” or “for example” in the embodiments of the present disclosure should not be construed as being more preferred or advantageous than other embodiments or design schemes. Specifically, the use of words such as “exemplary” or “for example” is intended to present the relevant concepts in a specific manner.

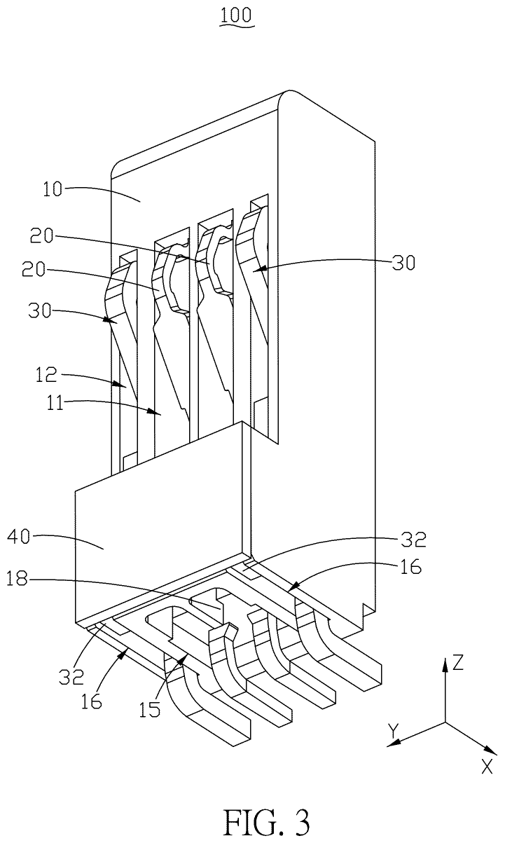

FIG. 3 shows an electrical connector 100 provided in a first embodiment of the present disclosure.

In some embodiments of the present disclosure, the electrical connector 100 can be applied to an electronic device (not shown) and can realize the transmission of electrical signals by electrically connecting with components in the electronic device. In some embodiments of the present disclosure, the type of signal transmitted by the electrical connector 100 is not specifically limited. For example, the signal transmitted by the electrical connector 100 can be, but is not limited to, differential pair signals.

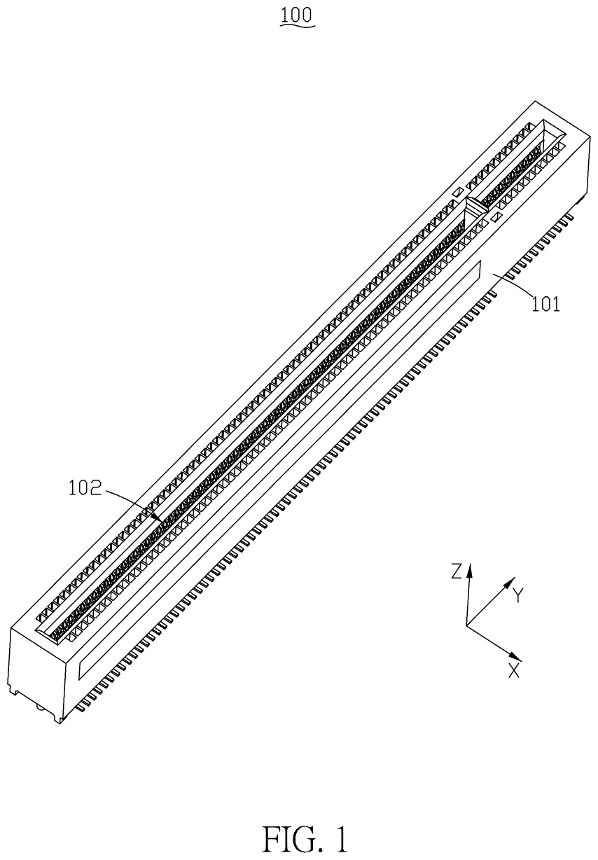

In some embodiments of the present disclosure, the height direction of the electrical connector 100 can be defined as the vertical direction, the length direction can be defined as a first horizontal direction, and the width direction can be defined as a second horizontal direction. For example, the vertical direction can be the Z direction and the opposite direction thereof as shown in FIGS. 1-3, the first horizontal direction can be the Y direction and the opposite direction thereof as shown in FIGS. 1-3, and the second horizontal direction can be the X direction and the opposite direction thereof as shown in FIGS. 1-3.

A first side and a second side are arranged opposite to each other in the second horizonal direction. The first side can be the side which the arrow in the X direction in FIGS. 1-3 points away from, and the second side can be the side which the arrow in the X direction points towards.

As shown in FIG. 1, the electrical connector 100 may include an insulating housing 10, a first terminal 20, a second terminal 30, and a shielding member 40. The electrical connector 100 is typically configured as an elongated strip extending along the first horizontal direction, including two opposite sidewalls 101, terminals fixed to the sidewalls 101, and a slot 102 disposed between the two sidewalls 101. In the present embodiment, for ease of description, the accompanying drawings only show a portion of the electrical connector 100. Namely, the insulating housing 10 is part of one of the sidewalls 101 of the electrical connector 100, and both the first terminal 20 and the second terminal 30 are fixed to the insulating housing 10 and each has a contact arm extending upward into the slot 102 and a pin extending downward out of the sidewall 101.

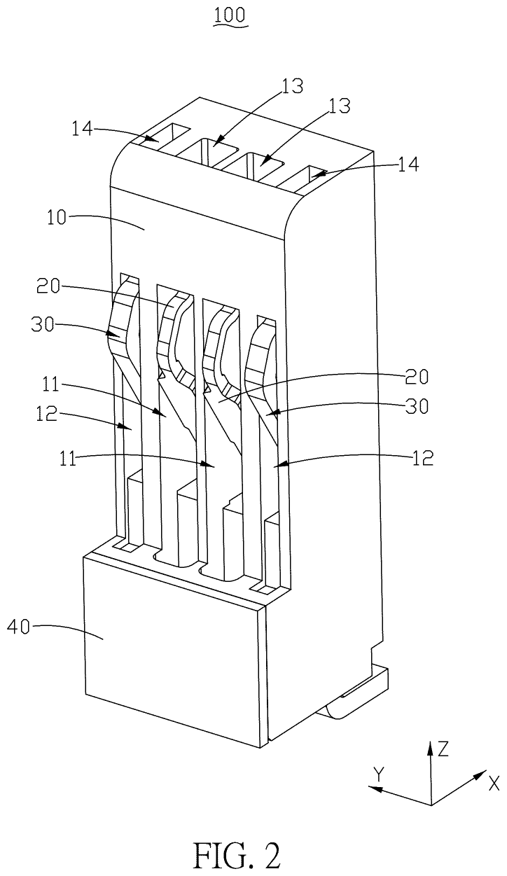

As shown in FIGS. 2 and 3, the insulating housing 10 may be made of an insulating material. The insulating housing 10 is formed with a first receiving groove 11 and a second receiving groove 12. The first receiving groove 11 and the second receiving groove 12 are spaced apart in the first horizontal direction. The first receiving groove 11 can pass through the first side of the insulating housing 10 in the second horizontal direction, and the second receiving groove 12 can pass through the first side of the insulating housing 10 in the second horizontal direction. The insulating housing 10 has a first interface 13 and a second interface 14 at the top thereof in the vertical direction, and a first opening 15 and a second opening 16 at the bottom thereof. The first interface 13 and the second interface 14 are spaced apart in the first horizontal direction, and the first opening 15 and the second opening 16 are also spaced apart in the first horizontal direction. The first receiving groove 11 is in fluid communication with the first interface 13 and the first opening 15. The second receiving groove 12 is in fluid communication with the second interface 14 and the second opening 16.

The first terminal 20 and the second terminal 30 are both made of conductive material. The first terminal 20 is partially received in the first receiving groove 11, and the pins thereof can extend out of the insulating housing 10 through the first opening 15. The second terminal 30 is partially received in the second receiving groove 12, and the pins thereof can extend out of the insulating housing 10 through the second opening 16. The first terminal 20 and the second terminal 30 are spaced apart in the first horizontal direction. In the present embodiment, the first terminal 20 is a differential signal terminal, and the second terminal 30 is a ground terminal. In the first horizontal direction, a pair of first terminals 20 arranged between two second terminals 30 form a differential terminal pair. The electrical connector 100 can have a plurality of differential terminal pairs. The present embodiment only describes one differential terminal pair.

The shielding member 40 can be plate-shaped. The shielding member 40 is fixedly mounted on the first side of the insulating housing 10 in the second horizontal direction, and the shielding member 40 avoids the first receiving groove 11 and the second receiving groove 12. The shielding member 40 can provide electromagnetic insulation, such that the differential signal pair does not interfere with the environment and is not interfered by the environment.

The first side of the electrical connector 100 in the second horizontal direction may face other components that can generate electromagnetic signals. The shielding member 40 arranged on the first side of the insulating housing 10 in the second horizontal direction can block electromagnetic signals and reduce the probability of electromagnetic signals interfering with the signal transmission of the first terminal 20. Meanwhile, the shielding member 40 can block the electromagnetic signals generated by the first terminal 20, reducing the propagation of these signals to the outside of the electrical connector 100 and minimizing the impact of these signals on other components.

In some embodiments of the present disclosure, the materials of the first terminal 20 and the second terminal 30 are not specifically limited. For example, both the first terminal 20 and the second terminal 30 can be made of, but are not limited to, copper alloy.

In some embodiments of the present disclosure, the material of the shielding member 40 is not specifically limited. For example, the material of the shielding member 40 can be, but is not limited to, copper alloy.

In some embodiments of the present disclosure, the material of the insulating housing 10 is not specifically limited. For example, the material of the insulating housing 10 can be, but is not limited to, plastic.

Other components of the electronic device can be connected to the pins of the first terminal 20 or the second terminal 30 extending from the bottom of the insulating housing 10, or indirectly connected via signal wires, thereby achieving electrical connection with the first terminal 20 or the second terminal 30.

Understandably, the first terminal 20 and the second terminal 30 can be inserted into the insulating housing 10 from the bottom through the first opening 15 and the second opening 16, respectively, and enter the first receiving groove 11 and the second receiving groove 12, thereby realizing the assembly of the first terminal 20 with the insulating housing 10 and the assembly of the second terminal 30 with the insulating housing 10.

The contact arms of the first terminal 20 and the second terminal 30 can undergo resilient deformation. When the first terminal 20 enters the first receiving groove 11 through the first opening 15, the first terminal 20 can abut the inner wall of the first receiving groove 11 and deform. When the first terminal 20 moves to a position corresponding to the first side of the first receiving groove 11 that pass through the insulating body 10, the contact arm of the first terminal 20 can return to its original shape under the action of a resilient force and extend into the slot 102 through the opening of the first receiving groove 11 on the first side of the insulating housing 10. When the second terminal 30 enters the second receiving groove 12 through the second opening 16, the second terminal 30 can deform by abutting the inner wall of the second receiving groove 12. When the second terminal 30 moves to a position corresponding to the first side of the second receiving groove 12 passing through the insulating body 10, the contact arm of the second terminal 30 can return to its original shape under a resilient force and pass through the opening of the second receiving groove 12 on the second side of the insulating body 10 to the slot 102.

In some embodiments of the present disclosure, the fixing method of fixed connection and fixed assembly is not specifically limited. For example, the fixing method may include, but is not limited to, fixing by welding, fixing by integral molding, fixing by adhesive, fixing bolt, and fixing by screw.

For example, the second terminal 30 can abut the side wall of the second receiving groove 12 in the first horizontal direction, and a fixed connection with the insulating body 10 is achieved through an oversize engagement with the second receiving groove 12.

In some embodiments of the present disclosure, the quantities of the first terminal 20 and the second terminal 30 are not specifically limited. The quantity of the first receiving grooves 11 is the same as the quantity of the first terminals 20, and the quantity of the second receiving grooves 12 is the same as the quantity of the second terminals 30. In the present embodiment, two first terminals 20 and two second terminals 30 are present. The two first terminals 20 are adjacent to each other in the first horizontal direction to form a differential terminal pair. The two second terminals 30 are positioned on opposite sides of the differential terminal pair, and the shielding member 40 is positioned on the first side of the differential terminal pair in the second horizontal direction.

Two first receiving grooves 11 and two receiving slots 12 are present. Each of the two first receiving grooves 11 corresponds to one of the two first terminals 20 and receives the corresponding first terminal 20. Each of the two second receiving grooves 12 corresponds to one of the two second terminals 30 and receives the two second terminals 30. The two first receiving grooves 11 are spaced apart in the first horizontal direction, and are positioned between the two second receiving grooves 12 in the first horizontal direction. The two second receiving grooves 12 are spaced apart from each other in the first horizontal direction.

Two first interfaces 13 can be present. The two first interfaces 13 can correspond respectively to the two first receiving grooves 11, and each of the interfaces is in fluid communication with the corresponding first receiving groove 11. The quantities of the second interfaces 14 and the second openings 16 can both be two. The two second interfaces 14 can correspond respectively to the two second receiving grooves 12, and the two second openings 16 can correspond respectively to the two second receiving grooves 12. Each of the second receiving grooves 12 is connected to the corresponding second interface 14 and the corresponding second opening 16.

The quantity of the first opening 15 can be one. The first opening 15 can be in fluid communication with the two first receiving grooves 11, and the pins of the two first terminals 20 can extend out of the insulating housing 10 through the first opening 15.

The following embodiments are described based on the case where both the quantities of the first terminals 20 and the second terminals 30 are two.

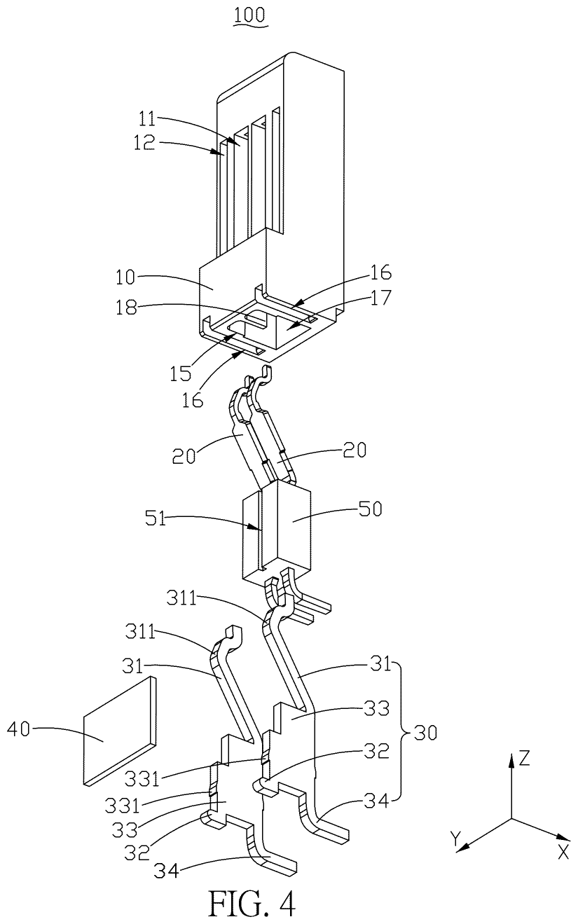

Referring to FIG. 4, in some embodiments, a fixing slot 17 is provided in the insulating housing 10, and the fixing slot 17 is in fluid communication with the first opening 15. The fixing slot 17 is in fluid communication with the two first receiving grooves 11. A positioning strip 18 is fixedly connected to the insulating housing 10, and the positioning strip 18 extends vertically. The positioning strip 18 is positioned in the fixing slot 17 between the two first receiving grooves 11.

The electrical connector 100 may further include a connecting base 50. The connecting base 50 is made of an insulating material. The two first terminals 20 can pass through the connecting base 50 vertically, such that the connecting base 50 is fitted to the two first terminals 20. The connecting base 50 is fixedly connected to the two first terminals 20. A positioning groove 51 can be formed on a first side of the connecting base 50 in the second horizontal direction, and the positioning groove 51 can pass through the connecting base 50 vertically. The connecting base 50 can enter the fixing slot 17 from the bottom of the insulating housing 10 through the first opening 15. The positioning strip 18 can be inserted and fixed in the positioning groove 51 to achieve a fixed connection between the connecting base 50 and the insulating housing 10.

Understandably, the connecting base 50 can be formed on to the first terminal 20 through injection molding to achieve the fitting and fixed connection with the first terminal 20. In some embodiments of the present disclosure, the material of the connecting base 50 is not specifically limited. For example, the material of the connector base 50 can be, but is not limited to, plastic.

Understandably, the connecting base 50 and the insulating housing 10 can be made of different types of materials. The structural strength of the insulating housing 10 can be greater than that of the connecting base 50, and the electromagnetic signal shielding performance of the connecting base 50 can be superior to that of the insulating housing 10.

Understandably, after the connecting base 50 is fixedly connected to the two first terminals 20, the connecting base 50 can pass through the first opening 15 together with the two first terminals 20 and be assembled together in the insulating housing 10, thus improving the ease of assembly of the electrical connector 100.

Understandably, the connecting base 50 can remain relatively fixed to the insulating housing 10. For example, the connecting base 50 can abut the inner wall of the fixing slot 17 and be oversized to engage the fixing slot 17 to achieve fixation in the fixing slot 17.

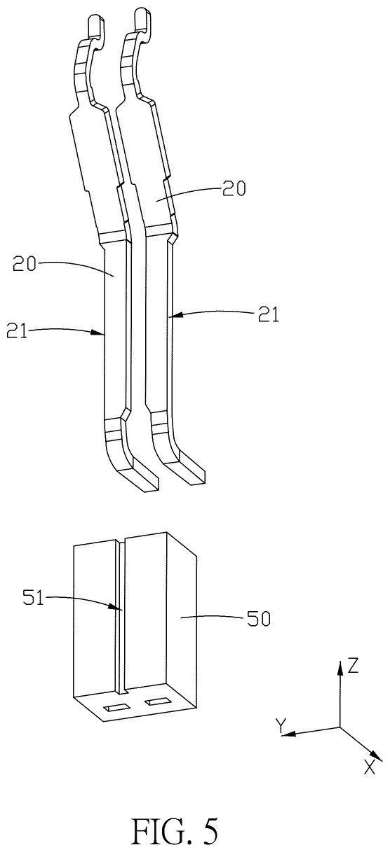

Referring to FIG. 5, in some embodiments, receding portions 21 are formed on opposite sides of the two first terminals 20 in the first horizontal direction. The connecting base 50 passes through the portions of the first terminal 20 having the receding portions 21. The inner wall of the groove 21 engages and fixes the connecting base 50. In this way, while maintaining the length of the connecting base 50 in the first horizontal direction, the distance between the two sides of the connecting base 50 and the corresponding first terminal 20 in the first horizontal direction can be increased, thereby improving the structural strength of the two sides of the connecting base 50 in the first horizontal direction, reducing the probability of damage to the two sides of the connecting base 50 in the first horizontal direction, and strengthening the protection of the first terminal 20.

In some embodiments, each of the second terminals 30 can abut and be electrically connected to the shielding member 40. Each of the second terminals 30 may include a resilient arm 31, an engagement portion 32, a fixing portion 33, and a leg portion 34 that are integrally formed. The resilient arm 31 extends upward from the fixing part 33. A portion of the resilient arm 31 is housed in the second receiving groove 12, and both sides of the resilient arm 31 in the first horizontal direction abut the side walls of the second receiving groove 12. The resilient arm 31 has a contact portion 311 on the first side thereof in the first horizontal direction. The contact portion 311 is formed by bending the middle portion of the resilient arm 31 towards the first side in the second horizontal direction, and extends from the opening of the second receiving groove 12 on the first side of the insulating housing 10 into the slot 102.

The leg portion 34 extends downward from the bottom of the fixing portion 33, and protrudes from the insulating body 10 through the second opening 16.

The fixing portion 33 can be a plate-like structure normal to the first horizontal direction. The fixing portion 33 can be housed in the second receiving groove 12 to shield electromagnetic signals in the first horizontal direction. Protrusions 331 protrude from both sides of the fixing portion 33 in the second horizontal direction, and the protrusions 331 are integrally formed and fixed with the fixing portion 33. The two protrusions 331 can engage and fix to the inner wall of the second receiving groove 12, thereby securing the second terminal 30 in the second receiving groove 12.

The engagement portion 32 protrudes from the fixing portion 33 in the second horizontal direction to the first side of the fixing portion 33. The engagement portion 32 passes through the insulating housing 10 in the second horizontal direction. The first side of the engagement portion 32 in the second horizontal direction abuts and is electrically connected to the shielding member 40.

Understandably, the two second terminals 30 can be grounded. After the two second terminals 30 are connected to the shielding member 40, the two second terminals 30 and the shielding member 40 can cooperate to form a cage, which blocks electromagnetic signals from both sides in the first horizontal direction and the first side in the second horizontal direction. In this way, the electrical connector 100 can strengthen the shielding from electromagnetic signals, reducing the probability of electromagnetic interference to the signal transmitted by the first terminals 20. At the same time, the radiation of electromagnetic signals generated by the first terminal 20 to the outside of the electrical connector 100 can be reduced, decreasing the impact of electromagnetic signals generated by the electrical connector 100 on other components.

Understandably, in the embodiments shown in FIGS. 2-4, the first terminal 20 is formed by stamping and bending a metal plate, and the second terminal 30 is formed by directly stamping a metal plate.

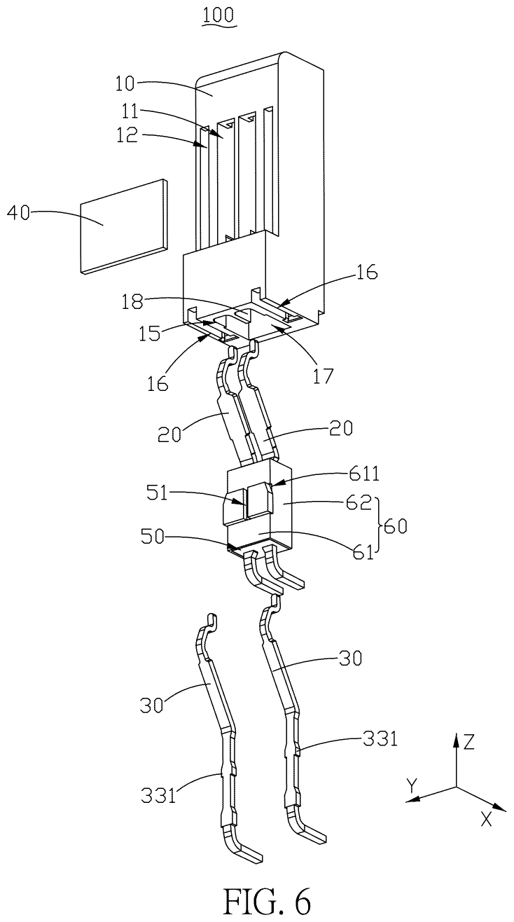

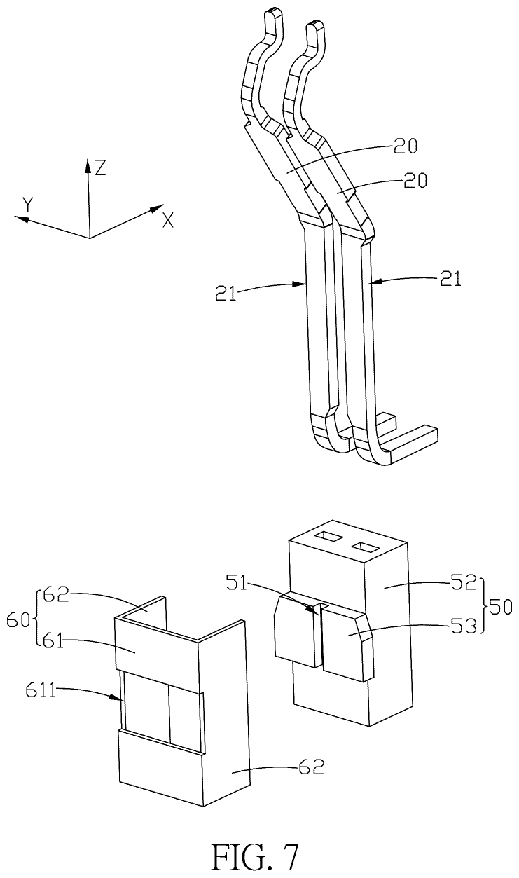

Referring to FIGS. 6 and 7, in the second embodiment, each of the second terminals 30 is not connected to the shielding member 40 and is spaced apart from the shielding member 40. The second terminal 30 does not have an engagement portion 32 or a fixing portion 33, and the resilient arm 31 of the second terminal 30 is integrally formed with the leg portion 34.

The electrical connector 100 may include a shielding cover 60. The material of the shield 60 can be the same as that of the shielding member 40. The shielding cover 60 can cover the outside of the connecting base 50 and is received in the fixing slot 17. The connecting base 50 can be oversized to engage the fixing slot, fixing the connecting base 50 and the shielding cover 60 in the fixing slot 17.

The shielding cover 60 can be a U-shaped structure, including a front shielding plate 61 and two side shielding plates 62. The front shielding plate 61 can partially shield the connecting base 50 and the two first terminals 20 from the first side in the second horizontal direction. The quantity of the side shielding plates can be two, and the two side shielding plates 62 are spaced apart in the first horizontal direction. The two side shielding plates 62 are integrally bent from both sides of the front shielding plate 61 in the first horizontal direction and extend towards the second side in the second horizontal direction. The two side shielding plates 62 can shield the connecting base 50 and the two first terminals 20 from both sides in the first horizontal direction.

The shielding cover 60 can block electromagnetic signals from both sides in the first horizontal direction and the first side in the second horizontal direction, thereby blocking electromagnetic signals radiated to the first terminals 20 and blocking electromagnetic signals generated by the first terminals 20, strengthening protection of the electrical connector 100 against electromagnetic interference, reducing the probability of electromagnetic interference affecting the signals transmitted by the first terminals 20. At the same time, the radiation of electromagnetic signals generated by the first terminals 20 to the outside of the electrical connector 100 is reduced, decreasing the impact of electromagnetic signals generated by the electrical connector 100 on other components.

The front shielding plate 61 can have a notch 611 that passes through the front shielding plate 61 in the first horizontal direction. The connecting base 50 may include a connecting portion 52 and a positioning portion 53. The two first terminals 20 may pass through the connecting portion 52, thereby fitting the connecting portion 52 to the two first terminals 20. The shielding cover 60 may cover the connecting portion 52. The connecting portion 52 may be oversized to engage the shielding cover 60. The positioning portion 53 may be positioned on a first side of the connecting portion 52 in the second horizontal direction, and the positioning portion 53 is integrally formed and fixed with the connecting portion 52. The positioning portion 53 may extend out of the shielding cover 60 through the notch 611. The positioning portion 53 is integrally formed and fixed with the connecting portion 52. A positioning groove 51 is formed on the first side of the positioning portion 53 in the second horizontal direction, and the positioning groove 51 extends vertically through the positioning portion 53.

Understandably, the shielding cover 60 may be fixed to the connecting base 50 first, and then assembled together into the fixing slot 17. The positioning portion 53 can extend out from the notch 611 of the shielding cover 60, such that the positioning groove 51 and the positioning strip 18 engage to fix the connecting base 50 in the fixing slot 17, such that the connecting base 50, the shielding cover 60, and the two first terminals 20 to be assembled in the insulating housing 10 at the same time.

Understandably, when the two second terminals 30 are not electrically connected to the shielding member 40, the two second terminals 30 and the shielding member 40 cannot cooperate to form a cage capable of shielding electromagnetic signals. In this case, the shielding cover 60 can enhance the blocking of electromagnetic signals radiated from the first side of the first terminal 20 in the second horizontal direction, and can also block electromagnetic signals radiated from both sides of the first horizontal direction towards the first terminal 20, strengthening protection of the electrical connector 100 against electromagnetic interference, reducing the probability of electromagnetic interference affecting the signal transmitted by the first terminal 20, and reducing the impact of the electromagnetic signals generated by the electrical connector 100 on other components.

Understandably, in the embodiments shown in FIGS. 5-7, both the first terminal 20 and the second terminal 30 can be formed by stamping and bending a metal sheet.

Understandably, in the embodiments shown in FIGS. 5-7, the protrusions 331 can protrude from both sides of the second terminal 30 in the first horizontal direction and engage the inner wall of the second receiving groove 12.

In still other embodiments, each of the second terminals 30 can be electrically connected to the shielding member 40 to cooperate and form a cage that can block electromagnetic signals. Simultaneously, the shielding cover 60 can be placed over the connecting base 50 to enhance the blocking of electromagnetic signals. Specific implementation methods can be seen in FIGS. 2-7 and the related descriptions, which is not repeated herein.

The electrical connector 100 provided by some embodiments of the present disclosure allows the shielding member 40 to block electromagnetic signals radiated from the outside of the electrical connector 100 to the first terminal 20, thereby reducing the influence of external electromagnetic signals on the signals transmitted by the first terminal 20 and improving the stability and accuracy of signal transmission of the electrical connector 100. Simultaneously, the shielding member 40 can block electromagnetic signals generated by the first terminal 20, reducing the impact of electromagnetic signals generated by the electrical connector 100 on other components and improving the reliability of the electronic device.

When the two second terminals 30 are connected to the shielding member 40 to form a cage capable of blocking electromagnetic signals, the cage blocks electromagnetic signals from both sides in the first horizontal direction and from the first side in the second horizontal direction, strengthening the blocking of electromagnetic signals by the electrical connector 100, reducing the probability of electromagnetic interference on the signals transmitted by the first terminal 20. At the same time, the radiation of electromagnetic signals generated by the first terminal 20 to the outside of the electrical connector 100 is also reduced, decreasing the impact of electromagnetic signals generated by the electrical connector 100 on other components.

When a shielding cover 60 is assembled to the connecting base 50, the shielding cover 60 can enhance the blocking of electromagnetic signals radiated from the first terminal 20 in the second horizontal direction, and can also block electromagnetic signals radiated from both sides of the first horizontal direction towards the first terminal 20, thus strengthening the blocking of electromagnetic signals by the electrical connector 100, reducing the probability of electromagnetic interference affecting the signal transmitted by the first terminal 20, and decreasing the impact of electromagnetic signals generated by the electrical connector 100 on other components.

It will be apparent to those skilled in the art that the present disclosure is not limited to the details of the above exemplary embodiments, and that the present disclosure can be implemented in other specific forms without departing from the spirit or essential characteristics of the present disclosure. Therefore, the above embodiments of the present disclosure should be considered exemplary and non-limiting in all respects. The scope of the present disclosure is defined by the appended claims rather than the foregoing description, and therefore all changes falling within the meaning and scope of the equivalents of the claims are intended to be included in the present disclosure.

1. An electrical connector, comprising:
an insulating housing having a fixing slot, two first receiving grooves and two second receiving grooves, the first receiving grooves and the second receiving grooves being spaced apart in a first horizontal direction;
two first terminals respectively received in the first receiving grooves, the two first terminals being adjacent to each other to form a differential terminal pair for transmitting differential pair signals;
two second terminals respectively received in the second receiving grooves for grounding, the two second terminals being positioned respectively on opposite sides of the differential terminal pair;
a shielding member arranged on the insulating housing, the shielding member contacting the two second terminals and being positioned on one side of the differential terminal pair in a second horizontal direction, the first horizontal direction and the second horizontal direction being perpendicular to each other; and
a connecting base assembled in the fixing slot of the insulating housing; wherein
the two first terminals are fixed to the connecting base.

2. The electrical connector as claimed in claim 1, wherein the fixing slot is in fluid communication with the first receiving groove.

3. The electrical connector as claimed in claim 2, wherein the insulating housing has a positioning strip arranged in the fixing slot, the connecting base has a positioning groove formed thereon, and the positioning strip is fixed to the positioning groove.

4. The electrical connector as claimed in claim 2, wherein the first terminal has a receding portion formed on one side thereof in the first horizontal direction, and an inner wall of the receding portion engages the connecting base.

5. The electrical connector as claimed in claim 2, wherein each of the second terminals comprises a fixing portion, a resilient arm extending upward from the fixing portion, a leg portion extending downward from the fixing portion, and an engagement portion protruding from the fixing portion, the resilient arm has a contact portion, and the engagement portions of the second terminals abut the shielding member.

6. The electrical connector as claimed in claim 5, wherein the fixing portion is a plate-like structure normal to the first horizontal direction, and two sides of the fixing portion in the second horizontal direction are each formed with a protrusion.

7. The electrical connector as claimed in claim 2, wherein the first terminal is formed by stamping and bending a metal plate, and the second terminal is formed by stamping a metal plate.

8. The electrical connector as claimed in claim 1, further comprising: a shielding cover covering the connecting base, the shielding cover has a front shielding plate and two side shielding plates integrally bent from two sides of the front shielding plate, the front shielding plate is positioned on one side of the differential terminal pair in the second horizontal direction, and each of the side shielding plates is positioned on the corresponding side of the differential terminals in the first horizontal direction and between the second terminals.

9. The electrical connector as claimed in claim 8, wherein the shielding cover is first fixed to the connecting base and then assembled into the fixing slot.

10. The electrical connector as claimed in claim 1, wherein the insulating housing has at least one slot, a plurality of the first terminals and a plurality of the second terminals are arranged aligned and arranged on two sides of the slot, and a plurality of the shielding covers are fixed in the insulating housing and correspond respectively to the differential terminal pairs.
